(19) United States
(12) Patent Application Publication
(10) Pub. No.: US 2019/0210798 A1
(43) Pub. Date: Jul. 11, 2019

(54) Solid Waste Evaluation and Weighing System

(71) Applicant: Trash Tracker Inc., San Marcos, CA (US)

(72) Inventor: Jordan Schultz, San Marcos, CA (US)

(73) Assignee: Trash Tracker Inc., San Marcos, CA (US)

(21) Appl. No.: 16/041,799

(22) Filed: Jul. 22, 2018

Related U.S. Application Data
(60) Provisional application No. 62/614,535, filed on Jan. 8, 2018.

(51) Int. Cl. B65F 1/14; B65F 3/04; G01G 19/08; G01G 23/20; G01G 23/37

(52) U.S. Cl. CPC B65F 1/1484; B65F 3/041; B65F 2003/022; G01G 23/20; G01G 23/3728; G01G 19/08

(57) ABSTRACT

A solid waste evaluation and weighing system, as described herein, comprises a device, wherein the device comprises hardware, software, firmware, and combinations thereof, designed to evaluate and calculate the weight of solid waste as it is picked up by garbage trucks. Contemplate embodiments aim to increase the granularity and quality of solid waste generated on a per-customer basis for the trash and recycling industry. Such information may be used for applications such as, but not restricted to, quantifying consumer behavior, improving operational efficiency, reducing operating costs and ensuring regulatory compliance.

This United States Utility Application claims priority to U.S. Provisional Patent Application Ser. No. 62/614535 entitled “Solid Waste Evaluation and Weighing System” filed on Jan. 8, 2018, which is commonly-owned and incorporated herein in its entirety by reference.

### BACKGROUND

Waste collection systems utilize trucks that collect trash, recycling, green waste, and other materials from residential and commercial customers. Customers sort materials into appropriate bins, and different trucks are used to collect these materials. Waste collection trucks drive specified routes and store the materials in a large onboard container. The trucks are typically weighed prior to the start of each route, and then again after collecting materials. The differential is stored, and used to quantify the amount of materials collected, and to derive costs for landfill, sorting, or other final processing of the waste.

U.S. Pat. No. 5,119,894 samples the weight of the waste bin as it is being picked up and moved vertically on the truck to determine the weight. The process uses weigh beams on the track to sample the weight during and after the deposition process. The patent focuses on sampling the weight at multiple points in order to bypass the problem of waste staying in the bin after deposition, so that the customer is charged appropriately. However, this process requires that the trucks be fitted with the weigh beams and the mechanism for determination of the weight of the bin throughout the deposition process. US Patent Publication 20140262552, EP0452821, EP0521847, and U.S. Pat. No. 5,837,945 are similar in that they require a lift mechanism that is fitted onto the truck that weighs the bins or requires retrofitting the current lift mechanism on the truck to weigh bins. DE3819169 also discloses similar systems “ . . . for weighing the content of refuse bins which are picked up, emptied and set down by a disposal vehicle having a pick-up device, the refuse bins being weighed after picking up or before emptying and the result of the weighing being fed to a data processing device and assigned to a specific user/customer.”

US Patent Publication 20180189412 published on Jul. 5, 2018 and its corresponding application Ser. No. 12/035288 disclose a container having a compactor and a bin for on-premises waste removal and monitoring. The bins in this publication are designed to be stable until picked up and couple with chutes that direct waste and trash into the bins. This publication also describes the use of RFID tags on the waste to track it from deposit through the transport process. US Patent Publication 20140262552 is similar in that it requires a lift mechanism that is fitted onto the truck that weighs the bins or requires retrofitting the current lift mechanism on the truck to weigh bins.

US Patent Publication 20150031343 discloses the use of global positioning information to track locations and conditions for things like trash or recycling trucks during their routes. They describe the need to eliminate paper tracking or cell-phone check-ins by the drivers and their supervisors. The system disclosed describes transmitting a report that includes “an estimated quantity of recyclable material” and even “determining recycling patterns in a particular area”, but this description does not contemplate a more detailed home-by-home or location-by-location weight and identification process.

Obtaining weights from each of the bins collected by the truck will eliminate the need for truck-level weights because the sum of the individual bins will total the final weight. In addition, collecting weights from each bin will allow for improved operational efficiency of the truck routes, improved waste reporting metrics, new communications to customers about the weight of their waste and ways to improve recycling, as well as open the door for per-weight charge systems. A contemplated weight system is critical to improvements in the marketplace, including changing consumer behavior and increasing operational efficiency. With the new weight data, truck routes can be optimized to reduce the amount of time spent on the road, thereby reducing fuel consumption and reducing greenhouse gas emissions.

In addition, increased recycling rates will help to conserve natural resources, and provide more post-consumer material for product manufacturing.

### SUMMARY OF THE SUBJECT MATTER

A system for determining the weight of residential or commercial waste is described herein that includes: at least one residential or commercial waste receptacle, wherein the receptacle contains at least one piece of waste, at least one global positioning system sensor, at least one weight-measuring, mass-measuring, density-measuring system, or combination thereof, at least one communications system, at least one waste collection device, utilizing the at least one waste collection device to collect the at least one piece of waste from the at least one residential or commercial waste receptacle, utilizing the at least one weight-measuring, mass-measuring, density-measuring system, or combination thereof to determine the weight, mass, density, or combination thereof of the at least one piece of waste, utilizing the at least one global positioning system sensor to provide information as to the location of the at least one residential or commercial waste receptacle, utilizing the at least one communications system to transmit the weight, mass, density, or combination thereof of the at least one piece of waste and the location of the at least one residential or commercial waste receptacle to a central collection point as a piece of location data.

### BRIEF DESCRIPTION OF THE FIGURES

FIG. 1 shows a contemplated system, as described herein.

FIG. 2 shows a contemplated sample waste collection truck and examples of where the data sensors may be placed.

FIG. 3 shows the lift arm of a contemplated truck and the types of data that may be sent to the microprocessor for analysis and conversion into a weight.

FIG. 4 shows a flow of the data and shows that the microprocessor takes in the data collected and uses an algorithm to convert the data into a weight.

### DETAILED DESCRIPTION

There are several conventional methods to attempt to determine the weight of waste being picked up and transported by a at least one waste collection device, that includes a truck or other vehicle. Some of these methods include comparing the weight of an empty truck versus the weight of the truck after a waste pickup is completed. Other methods attempt to accurately capture the weight of the waste bin during and after waste collection, as described in the Background section.

As outlined earlier, the ability to obtain accurate weights of the trash or waste collected from each of the bins collected by the truck will eliminate the need for truck-level weights because the sum of the individual bins will total the final weight. The number of patents and patent applications related to this space indicate that accuracy is still something that is needed in the industry.

In addition, collecting weights from each bin will allow for improved operational efficiency of the truck routes, new communications to customers about the weight of their waste and ways to improve recycling, improved waste reporting metrics, as well as opening the door for per-weight charge systems. In these systems, it is important to capture the weight of the trash or waste actually collected versus the weight of the trash or waste in the bin to begin with given that trash or waste might be left behind in the bin for various reasons.

Contemplated weight systems are critical to improvements in the marketplace, including changing consumer behavior and increasing operational efficiency. With the new weight data, truck routes can be optimized to reduce the amount of time spent on the road, thereby reducing fuel consumption and reducing greenhouse gas emissions. In addition, increased recycling rates will help to conserve natural resources, and provide more post-consumer material for product manufacturing.

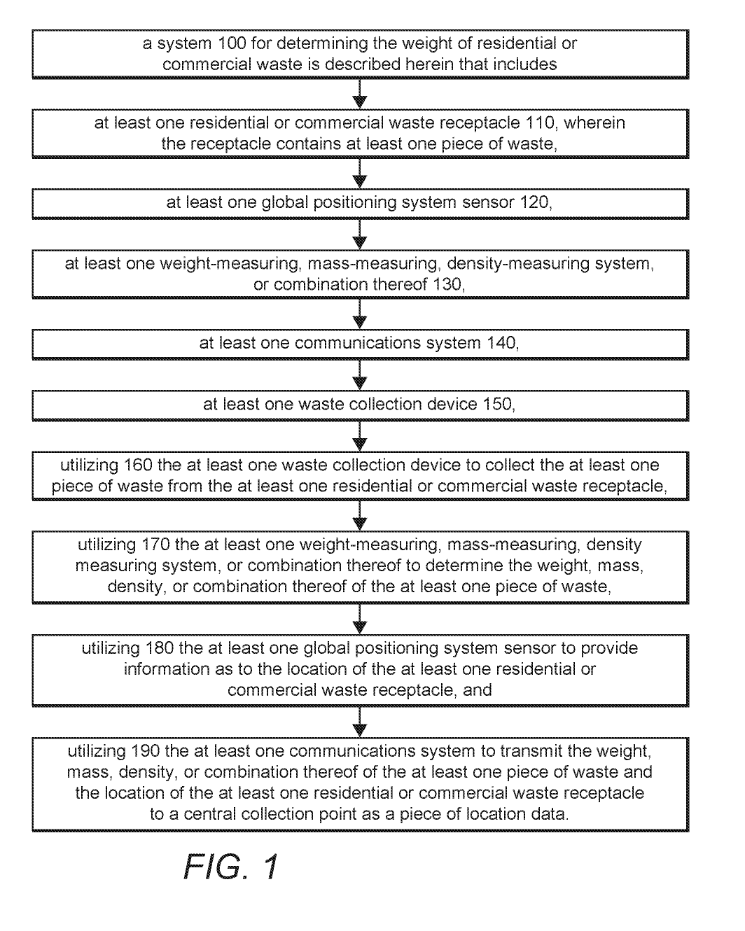

Specifically and as shown in FIG. 1, a system 100 for determining the weight of residential or commercial waste is described herein that includes: at least one residential or commercial waste receptacle 110, wherein the receptacle contains at least one piece of waste, at least one global positioning system sensor 120, at least one weight-measuring, mass-measuring, density-measuring system, or combination thereof 130, at least one communications system 140, at least one waste collection device 150, utilizing 160 the at least one waste collection device to collect the at least one piece of waste from the at least one residential or commercial waste receptacle, utilizing 170 the at least one weight-measuring, mass-measuring, density-measuring system, or combination thereof to determine the weight, mass, density, or combination thereof of the at least one piece of waste, utilizing 180 the at least one global positioning system sensor to provide information as to the location of the at least one residential or commercial waste receptacle, and utilizing 190 the at least one communications system to transmit the weight, mass, density, or combination thereof of the at least one piece of waste and the location of the at least one residential or commercial waste receptacle to a central collection point as a piece of location data.

Contemplated embodiments include at least one residential or commercial waste receptacle, wherein the receptacle contains at least one piece of waste. For the purposes of the present disclosure, the term “waste” is used in its broadest sense and includes trash and recyclables. It not only includes items being destroyed or put in a landfill, such as trash, but also recyclables, such as paper, corrugation board, cardboard, etc. The term “receptacle” or “container” may be used interchangeably, is also used in its broadest sense and can include bins, balers, compactors, etc. for holding waste and/or recyclables.

Contemplated embodiments include at least one global positioning system sensor. These types of sensors are utilized in numerous systems, vehicles, phones, computers, along with other items and systems. Contemplated global positioning systems are utilized to provide information as to the location of the at least one residential or commercial waste receptacle, the location of the trash, waste, or recycling truck, or a combination thereof.

As mentioned, contemplated systems comprise at least one weight-measuring, mass-measuring, density-measuring system, or combination thereof, at least one communications system, at least one waste collection device, wherein the system utilizes the at least one weight-measuring, mass-measuring, density-measuring system, or combination thereof to determine the weight, mass, density, or combination thereof of the at least one piece of waste.

In some embodiments, the at least one weight-measuring, mass-measuring, density-measuring system, or combination thereof to determine the weight, mass, density, or combination thereof of the at least one piece of waste comprises at least two independent and separate points of waste weight comparison. In other embodiments, the at least two independent and separate points of waste weight determination comparison comprise a weighing function on the at least one waste collection device, a weighing function on the receptacle, an exertion component on the at least one waste collection device, a time measurement component on the at least one waste collection device, or a combination thereof. It is understood that this concept of “at least two independent and separate points of waste weight determination comparison” means that one may be collecting data from the lift mechanism and the hydraulics system, or the waste receptacle and the hydraulics system, or the lift mechanism and the engine exertion data, etc. This type of data collection is contemplated herein, because it is more accurate and reliable than conventional methods already disclosed.

In some embodiments, a contemplated exertion component on the at least one waste collection device comprises monitoring a hydraulics system on the at least one waste collection device, monitoring an engine system on the at least one waste collection device, or a combination thereof. In contemplated embodiments, monitoring a hydraulics system on the at least one waste collection device comprises a temperature component, a pressure component, or a combination thereof.

Contemplated embodiments describe a method, and related algorithms, hardware, firmware, software, and combinations thereof, for weighing solid waste bins on a per customer basis for the residential and commercial sectors. Solid waste is an industry standard term that is used to refer to garbage, green waste and recycling material.

Contemplated methods utilize a variety of information obtained from the collection truck for the calculation of the weight of solid waste, including but not limited to the time taken to lift the bin, the time taken to place the bin back, engine related information from the truck, hydraulic system information, and bin identification technologies such as, but not restricted to, RFID, and geo-location information such as, but not restricted to, GPS. The methods and algorithms utilized for the calculation of weights are capable of using different data sources, including but not limited to, statistical, deterministic, structured (part deterministic, part statistical), and unstructured.

The calculated weight information can be stored in a computer on the truck or communicated and transmitted to a Cloud-based database continuously or as a batch process. The weight information is tagged with information regarding the location of the household such as, but not limited to, GPS location and address. While contemplated embodiments are directed towards households, the underlying method, hardware, firmware, software, and combinations thereof are capable of weighing solid waste for commercial customers.

A contemplated communications system utilizes any suitable communications technology to transmit collected data to either a local storage database or a central storage database. Contemplated communications systems may utilize WI-FI or wired technology, wherein the data is stored locally on the truck, and once the truck reaches its final termination point, the data is transmitted to a storage and analysis database.

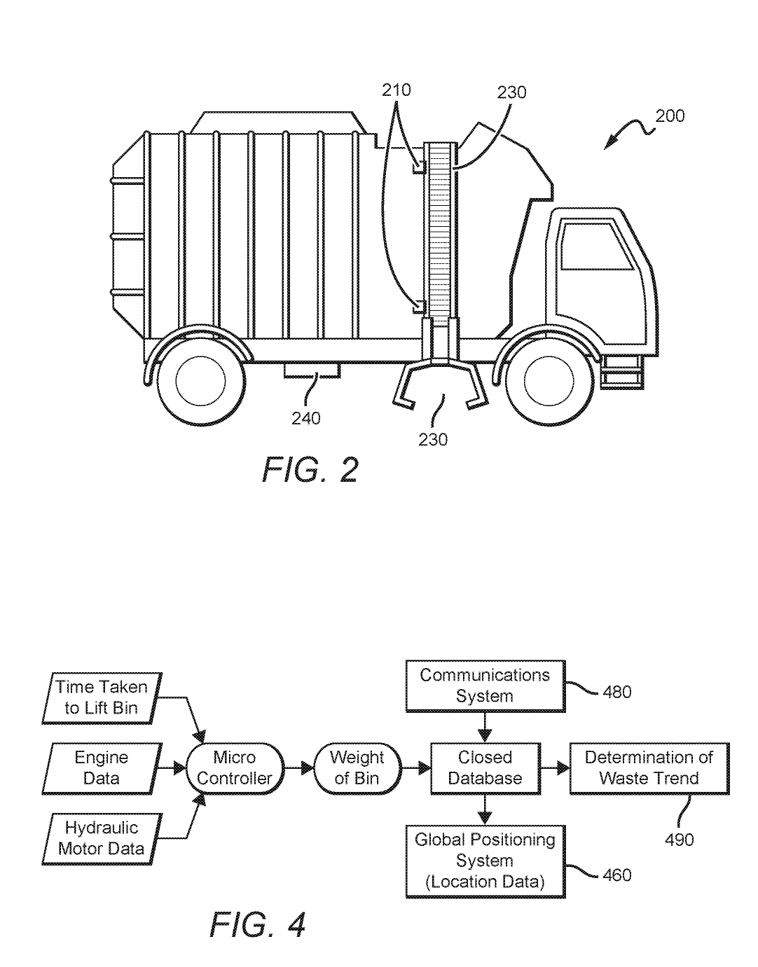

The Figures show various ways of setting up and utilizing contemplated methods. For example, FIG. 2 shows a contemplated sample waste collection truck 200 and examples of where the sensors 210 that we pull data from may be. In this embodiment, there are sensors 210 on the lift mechanism 230 and sensors 210 on the truck 200 in the form of hydraulic motor systems 240.

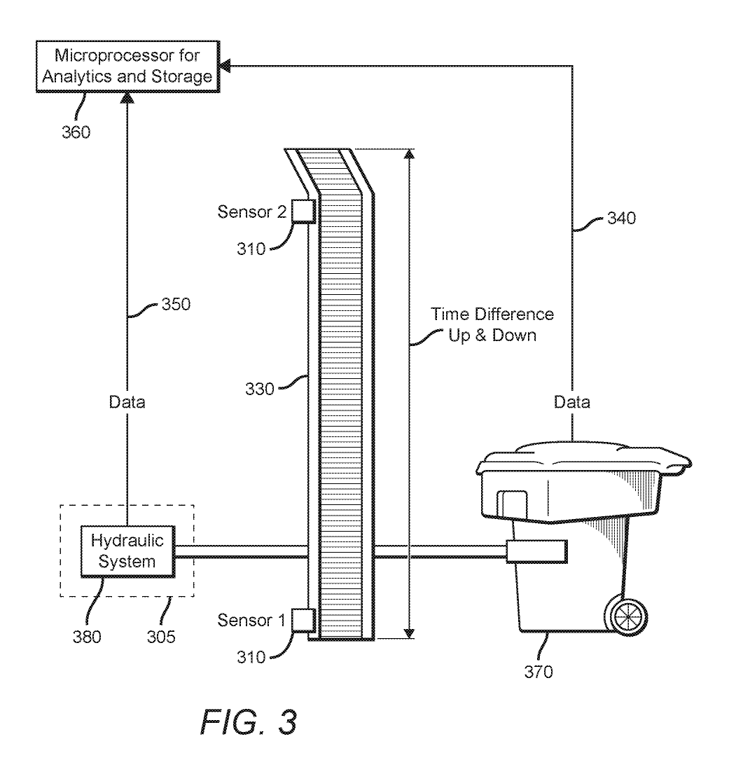

FIG. 3 shows contemplated sensors 310 on a lift arm or lift rail (lift mechanism) 330 of a contemplated vehicle, such as a truck, boat, or car (not shown in this Figure in full but represented as box 305) and the types of data 340 and 350 we may send to the microprocessor 360 for analysis and conversion into a weight. Data 340 may comprise the time it takes to lift the bin 370 from the ground to the top, may comprise the weight of the bin 370, may comprise the size of the bin 370, or a combination thereof. Data 350 may comprise a weighing function on the at least one waste collection device, an exertion component on the at least one waste collection device, a time measurement component on the at least one waste collection device, or a combination thereof. In some embodiments, the exertion component on the at least one waste collection device comprises monitoring a hydraulics system 380 on the at least one waste collection device, monitoring an engine system on the at least one waste collection device, or a combination thereof. In other embodiments, monitoring a hydraulics system on the at least one waste collection device comprises a temperature component, a pressure component, or a combination thereof. Once the data 340 and 350 is sent to the microprocessor 360, the data may be analyzed locally, sent through a contemplated communications system (shown in FIG. 4) to a central processing system to be analyzed later, or a combination thereof. As used herein, a lift mechanism comprises a lift arm or grabber that is used to grab and hold a waste receptacle and a lift rail that is coupled with the lift arm or grabber and is used to transport the lift arm or grabber, along with the waste receptacle up off of the ground or water and into a waste collection area on the vehicle.

FIG. 4 shows a contemplated flow 400 of the data, which includes in this embodiment the time taken to lift the bin 410, the engine data 420, and the hydraulic motor data 430, and shows that the microprocessor/microcontroller 440 takes in the data collected and uses an algorithm (not shown) to convert the data into a weight of the bin 450. This information is combined with global positioning data from the global positioning system 460 and is transmitted to the cloud database or other central storage system 470 by using the communications system 480. Contemplated systems for determining the weight of residential or commercial waste further comprise analyzing the piece of location data in combination with at least one other piece of location data to determine a waste trend for the location.

Contemplated embodiments and methods of evaluating and weighing trash and refuse comprise using data pulled from sensors on the truck that record pressure within the hydraulics, time taken to lift a bin, and engine data. Those sensors may already be on the truck or may be installed near the lift arm and within the hydraulic system. Contemplated data will be fed into a microcontroller that stores the data and then feeds it into an algorithm that can relate those values with the weight of the bin. The weight measurement is then tagged with GPS coordinates generated by the microcontroller so that the bin can be associated with an address. That information is then all fed into a database via wireless connection on the microcontroller. Once the data is present within the database it can be securely stored and accessed and presented to the utility or residential homeowner using a custom user interface.

Specifically, a contemplated device with some combination of hardware, software and firmware wherein said device receives information from sensors on a truck, engine related information and hydraulic system information to calculate the weight of solid waste picked up by the truck is disclosed and shown in the Figures. Contemplated devices and systems determine the weight of solid waste generated on a per-household basis, and calculates the weight of garbage, green waste and recycling materials generated on a per-pickup basis.

Contemplated systems for determining the weight of residential or commercial waste include: collecting at least one piece of waste from the at least one residential or commercial waste receptacle, collecting a piece of location data, collecting at least one additional piece of different location data; and analyzing the piece of location data in combination with at least one other piece of different location data to determine a waste trend for the location. In addition, contemplated systems for determining the weight of residential or commercial waste include at least one piece of location data, wherein the at least one piece of location data comprises a weight, mass, density, or combination thereof of the at least one piece of waste and the location of the at least one residential or commercial waste receptacle.

Contemplated embodiments comprise at least one communications system, wherein the overall system utilizes the at least one communications system to transmit the weight, mass, density, or combination thereof of the at least one piece of waste and the location of the at least one residential or commercial waste receptacle to a central collection point as a piece of location data. Contemplated devices utilize wireless forms of communication to communicate data. However, in some contemplated embodiments, data may be stored locally and then transmitted to a central database once the truck or at least one waste collection device reaches the central processing station. In some contemplated embodiments, contemplated devices are powered by the truck battery or by the use of the truck.

Contemplated devices operate or include an information platform that authenticates and transmits solid waste information to waste management companies, their customers and third-party entities.

Thus, specific embodiments, methods of a solid waste and refuse evaluation and weighing system have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for determining the weight of residential or commercial waste, comprising:
at least one residential or commercial waste receptacle, wherein the receptacle contains at least one piece of waste,
at least one global positioning system sensor,
at least one weight-measuring, mass-measuring, density-measuring system, or combination thereof,
at least one communications system,
at least one waste collection device,
utilizing the at least one waste collection device to collect the at least one piece of waste from the at least one residential or commercial waste receptacle,
utilizing the at least one weight-measuring, mass-measuring, density-measuring system, or combination thereof to determine the weight, mass, density, or combination thereof of the at least one piece of waste,
utilizing the at least one global positioning system sensor to provide information as to the location of the at least one residential or commercial waste receptacle, and
utilizing the at least one communications system to transmit the weight, mass, density, or combination thereof of the at least one piece of waste and the location of the at least one residential or commercial waste receptacle to a central collection point as a piece of location data.

2. The system for determining the weight of residential or commercial waste of claim 1, further comprising analyzing the piece of location data in combination with at least one other piece of location data to determine a waste trend for the location.

3. The system for determining the weight of residential or commercial waste of claim 1, wherein the at least one global positioning system sensor is located on the at least one residential or commercial waste receptacle, on the at least one waste collection device, or on a combination thereof.

4. The system for determining the weight of residential or commercial waste of claim 1, wherein at least one waste collection device comprises a truck, a boat, a vehicle, or a car.

5. The system for determining the weight of residential or commercial waste of claim 1, wherein the at least one weight-measuring, mass-measuring, density-measuring system, or combination thereof to determine the weight, mass, density, or combination thereof of the at least one piece of waste comprises at least two independent and separate points of waste weight comparison.

6. The system for determining the weight of residential or commercial waste of claim 5, wherein the at least two independent and separate points of waste weight determination comparison comprise a weighing function on the at least one waste collection device, a weighing function on the receptacle, an exertion component on the at least one waste collection device, a time measurement component on the at least one waste collection device, or a combination thereof.

7. The system for determining the weight of residential or commercial waste of claim 5, wherein the exertion component on the at least one waste collection device comprises monitoring a hydraulics system on the at least one waste collection device, monitoring an engine system on the at least one waste collection device, or a combination thereof.

8. The system for determining the weight of residential or commercial waste of claim 7, wherein monitoring a hydraulics system on the at least one waste collection device comprises a temperature component, a pressure component, or a combination thereof.

9. The system for determining the weight of residential or commercial waste of claim 1, wherein the at least one communications system transmits at least one collected data to either a local storage database or a central storage database.

10. The system for determining the weight of residential or commercial waste of claim 8, wherein the at least one communications system utilizes WI-FI or wired technology.

11. The system for determining the weight of residential or commercial waste of claim 8, wherein the at least one collected data is stored locally on the at least one waste collection device.

12. The system for determining the weight of residential or commercial waste of claim 10, wherein when the at least one waste collection device reaches its final termination point, the at least one collected data is transmitted to a storage and analysis database.

13. The system for determining the weight of residential or commercial waste of claim 12, wherein the storage and analysis database is located in or stored on the cloud.

14. A system for determining the weight of residential or commercial waste comprising:
collecting at least one piece of waste from the at least one residential or commercial waste receptacle,
collecting a piece of location data,
collecting at least one additional piece of different location data; and
analyzing the piece of location data in combination with at least one other piece of different location data to determine a waste trend for the location.

15. The system for determining the weight of residential or commercial waste of claim 14, wherein the at least one piece of location data comprises a weight, mass, density, or combination thereof of the at least one piece of waste and the location of the at least one residential or commercial waste receptacle.
